(19) United States
(12) Patent Application Publication
(10) Pub. No.: US 2010/0165813 A1
(43) Pub. Date: Jul. 1, 2010

(54) OPTICAL RECORDING APPARATUS WITH HIGH-SPEED FORWARD LASER POWER CONTROL (LPC)

(75) Inventor: James Joseph Anthony Mc Cormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,508

(22) PCT Filed: Nov. 24, 2006
(86) PCT No.: PCT/IB06/54427

§ 371 Date: May 30, 2008

(30) Foreign Application Priority Data
Dec. 1, 2005 (EP) 05111573.1

(51) Int. Cl. G11B 27/36

(52) U.S. Cl. 369/53.26; G9B/27.052

(57) ABSTRACT

The invention relates to an optical recording apparatus on optical carrier or disk, the apparatus has means for sampling a power level of an irradiation beam, e.g. a laser beam, that is capable of recording data in a data region (101) in response to an predefined input signal (NRZ). The irradiation beam (5) has a substantially constant power level in a first period (MT1), where the first period (MT1) is longer than the period of time associated with the maximum code run length (MRL) of the encoding scheme. Forward photo sensing means (FS 41, 40) is adapted to sample the power level in at least a sub-period of time (ST1) of the first period (MT1). The invention relaxes the requirements of the forwarding photo sensing means (FS), as the first period (MT1) may be extended beyond the time that was previously available for monitoring the power level of the irradiation beam.

The present invention relates to an optical recording apparatus for recording on an associated optical carrier, the apparatus comprising means for sampling a power level of an irradiation beam, e.g. a laser beam, used for recording. The invention also relates to corresponding processing means and a corresponding method.

During optical recording of an optical disk or carrier, for rewriteable media, a laser beam is applied to selectively crystallize or make amorphous a phase-changing material in dependency of the data to be writing on the optical disk or carrier. Equally, for write-once media, a laser beam is applied to selectively to alter/burn away/deform (dye) material or not, in dependency of the data to be writing on the optical disk or carrier. The laser is driven using a pulse form that contains higher frequency component than the channel rate itself. This has the form of a multi-level pulse with the purpose of writing a “mark” or a “space” at a given length in response to the encoded data. The conversion of encoded data, also known as no-return-to-zero data (NRZ), to a pulse train with higher time resolution and multiple power levels is performed by a so-called write strategy. It is therefore imperative that the power of the applied laser beam is controlled with a relatively high degree of precision in order to implement the specific write strategy for a given set of data on a certain optical disc.

Typically, laser power control (LPC) is performed by sampling a laser beam feedback signal from a photodiode named the forward sense (FS). The photodiode is either positioned within a portion of the laser beam, or alternatively a portion of the laser beam is directed to the photodiode via beam splitting means, e.g. a so-called leaky prism beam splitter or a leaky mirror. Alternatively, laser power control (LPC) could be performed by test writing in dedicated power calibration areas (PCA) on the disc in the same regions where “optimum power control” (OPC) is also performed, but this is an open-loop/feed-forward method and it is not as stable and efficient as forward sense (FS) control. Forward sense control may also be referred to as forward monitor (FM) control.

With the current trend of increasing writing speed to the optical disk, in particular for the Blu-Ray Disc (BD), the time intervals within and between (i.e. land zone) the multi-pulse trains in the write strategy are correspondingly shortened. This has the effect that sampling of the laser power level by the forward sensing means (FS) becomes more and more difficult due to settling time of the photo diode and/or the corresponding amplifier. Particularly, the amplifiers must have nano second response time which may be quite difficult and/or expensive to achieve. It may also be noted that the gain of the available photo diodes—in general—decreases with decreasing wavelength. Thus, going from DVD to BD technology and even further down in wavelength requires more gain and this in turn means that for the same op-amp, with same gain-bandwith product, the settling times will increase.

US 2005/0083828 discloses a solution to this problem by application of an averaging variant of the forwarding sensing (FS) method. In short, the laser is driven by a write strategy so that a multi-pulse having a fixed duty cycle ratio with two power levels is emitted. The forward measured power during the multi-pulse is averaged, and knowing the duty cycle ratio it is possible to obtain the actual power of each of the two power levels from a power calibration procedure. However, this is also an indirect approach and it requires—inter alia—that the duty cycle ratio and the calibration remains constant, which may be difficult for such a fast alternating multi-pulse. Also for constant angular velocity (CAV) or CAV-like writing, due to pulse form variations that do not scale with frequency actual variations of this averaged value with respect to writing position (i.e. linear writing speed) may occur.

Hence, an improved optical recording apparatus would be advantageous, and in particular a more efficient and/or reliable power control of the irradiation beam of the recording apparatus would be advantageous.

Accordingly, the invention preferably seeks to mitigate, alleviate or eliminate one or more of the above-mentioned disadvantages singly or in any combination. In particular, it may be seen as an object of the present invention to provide an optical recording apparatus that solves the above mentioned problems of the prior art with power control of the applied irradiation beam.

This object and several other objects are obtained in a first aspect of the invention by providing an optical recording apparatus for recording on an associated optical carrier, said carrier comprising data regions and optionally power control regions, the optical recording apparatus comprising

an irradiation source adapted for emitting an irradiation beam, said beam being capable of recording data in a data region in response to an predefined input signal (NRZ), said predefined input signal (NRZ) being encoded with an encoding scheme having a maximum code run length (MRL), and

forward photo sensing means (FS) adapted for monitoring the power level of the irradiation beam emitted from the irradiation source,

wherein the irradiation beam has a substantially constant power level in a first period (MT1), said first period being longer than the period of time associated with the maximum code run length (MRL), the forward photo sensing means (FS) being adapted to sample the power level in at least a sub-period of time (ST1) of the first period (MT1).

The invention is particularly, but not exclusively, advantageous for obtaining an optical recording apparatus that relaxes the requirements of the forwarding photo sensing means (FS) as the first period (MT1) may be extended beyond the time that was previously available for monitoring the power level of the irradiation. All of the previous optical recording standards (before BD) hitherto known have no provision for allowing an “illegal” or non-conforming effect to be written on the medium without using error correction capacity. Hence, transmitting a non-standard encoded data stream was not possible without disimproving recording quality.

The present invention provides means to create special “illegal” or non-conforming write strategies opening a fundamentally new way of performing laser power control (LPC) in optical recording without loss of writing quality. It should be noted that the methodology of the present invention can be also used in older standards (e.g. CD writing or DVD writing) if some use of the error correction capacity for this purpose at read-back is tolerated.

More specifically, the present invention allows for more simplified high speed writing to an optical carrier, as the bandwidth or the forward photo sensing means (FS) may be lowered, and both the timing resolution and the control resolution of the sampling means associated with the forward photo sensing means (FS) may be relaxed. In addition, the present invention provides an opportunity for robust simple control for even higher writing speed for the Blu-Ray technology than the writing speed that has been realized hitherto.

The invention applies sampling of the substantially constant power level during at least a sub-period of the first period (MT1). The length of the sub-period may be any duration within the first period (MT1). Sampling may also be performed in more than one sub-period within the first period (MT1). In general, sampling is normally defined as the process of selecting regularly spaced points in time in which to record the level of a signal. However, within the context of the present invention sampling may also include irregularly spaced points in time. Thus, there may a first interval of time within the said sub-period (ST1), wherein no recordation of the level of a signal is performed. That first interval of time may be followed by a subsequent second interval of time, wherein recordation of the level of a signal is performed at regularly spaced points in time.

More advantageously, the present invention may facilitate sampling at a higher power level than previously possible. The higher power levels, e.g. the write power level for a three level laser write strategy, are difficult to sample because the settling time of the amplifier and/or photo detector of the forward photo sensing means (FS) is in general increasing with the power level. This will be further illustrated below.

It should be noted that the period of time associated with the maximum code run length (MRL) varies depending on the specific operation condition of the optical recording apparatus in question as it will be appreciated by a skilled person in this technical field. Thus, the time may depend on the rotational control of the carrier (i.e. CAV or CLV), the channel rate, the writing speed, and the applied power level, etc.

In an embodiment of the invention the first period (MT1) may be at least two times, preferably at least three times, and even more preferably at least four times, longer than the period of time associated with the maximum code run length (MRL). The length of the first period is limited from above by overheating of the irradiation source. On the other hand, the length of the first period should also have a sufficient length in order to obtain good accuracy of the sampled power level. It is contemplated that the first period may also have a length in the interval from one to two multiplied by the period of time associated with the maximum code run length (MCL); i.e. the first period (MT1) may be 1.2, 1.4, 1.6, or 1.8 times the period of time associated with the maximum code run length (MRL).

In a preferred embodiment, the forward photo sensing means (FS) may comprise a photo detector and an amplifier connected thereto, the amplifier being adapted for outputting an electrical signal indicative of the power of the radiation beam. Advantageously, the power level may then be substantially constant after a transient rise period of the photo detector and/or the amplifier.

Alternatively or additionally, the power level may then also be substantially constant before a decaying fall period of the photo detector and/or the amplifier. In that case, the length of first period (MT1) may additionally be related to a characteristic decaying fall period of the photo detector and/or the amplifier. Thus, the length of the first period may be adjusted so that the fall period is over, and thereby not letting the decay influencing a subsequent laser power control sampling.

Beneficially, the sampled power level may be applied in connection with a relationship between the power level of the irradiation beam and a current driving the radiation source. Typically, such a relationship is linear, at least within a certain range of parameters. Such a relationship is disclosed in U.S. Pat. No. 6,577,655, granted to the same applicant. U.S. Pat. No. 6,577,655 is hereby incorporated by reference in its entirety. Applying the principle of U.S. Pat. No. 6,577,655 within the context of the present invention it may be possible to sample for example one power level of the irradiation source and exploit the aforementioned relationship to obtain knowledge about the characteristics of the irradiation source. This may for example be performed during a manufacturing step of the optical recording apparatus.

Further, at least one additional sampled power level may be applied to calibrate a relationship between the power level of the irradiation beam and a current driving the radiation source. This may for example take place during a start-up procedure of the optical recording apparatus and/or if a control procedure of the optical recording apparatus indicates that a recalibration is needed and/or beneficial for the operation of the apparatus.

Advantageously, the substantially constant power may be sampled in said sub-period (ST1) of time, where the sub-period is positioned before and/or after a data region of the associated optical carrier. Preferably, the constant power level is sampled in dedicated power control areas (PCA) or regions, the present invention may also under certain conditions applied laser power control (LPC) in a data region of the associated carrier as it will be explained in more detail below.

In another embodiment of the invention, the irradiation beam may additionally have a substantially constant power level in a second period (MT2), said second period being longer than the period of time associated with the maximum code run length (MRL), the forward photo sensing means (FS) being adapted to sample the power level in at least a sub-period of time (ST1) of the second period (MT1).

The power level in the first period (MT1) may be chosen from the group of: write level, erase level, and bias level, as these level are typically applied in a write strategy. However, other levels, e.g. calibration or measurement levels, may equally be applied

In a second aspect, the invention provides processing means adapted for controlling an optical recording apparatus capable of recording on an optical carrier, said carrier comprising data regions and optionally power control regions, the processing means being adapted to

1) forward a predefined input signal (NRZ) to an irradiation source, said predefined input signal (NRZ) being encoded with an encoding scheme having a maximum code run length, wherein an irradiation beam of the irradiation source has a substantially constant power level in a first period, said first period being longer than the period of time associated with the maximum code run length, and

2) receive a forward sensing signal indicative for the power level of an irradiation beam emitted from the irradiation source,

the processing means further being adapted to sample the power level of the irradiation beam in at least a sub-period of time (ST1) of the first period (MT1).

The processing means may comprise one or more processing units. Thus, a central processing unit (CPU) may constitute processing means in connection with one or more auxiliary processing units.

In a third aspect, the invention provides a method for operating an optical recording apparatus for recording on an optical carrier, said carrier comprising data regions and optionally power control regions, the method comprising the steps of

emitting an irradiation beam from an irradiation source, said beam being capable of recording data in a data region in response to an predefined input signal (NRZ), said predefined input signal (NRZ) being encoded with an encoding scheme having a maximum code run length (MRL), wherein the irradiation beam has a substantially constant power level in a first period (MT1), said first period being longer than the period of time associated with the maximum code run length (MRL),

monitoring by forward photo sensing means the power level of the irradiation beam emitted from the irradiation source, and

sampling the power level of the irradiation beam in at least a sub-period of time (ST1) of the first period (MT1).

In a fourth aspect, the invention relates to a computer program product being adapted to enable a computer system comprising at least one computer having data storage means associated therewith to control an optical recording apparatus according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical recording apparatus may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

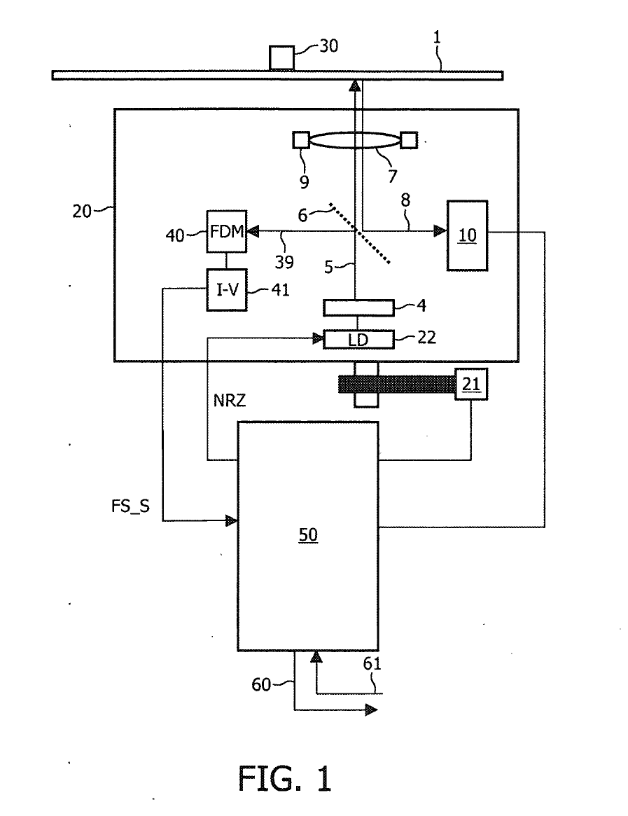

FIG. 1 is a schematic diagram of an embodiment of an optical recording apparatus according to the invention,

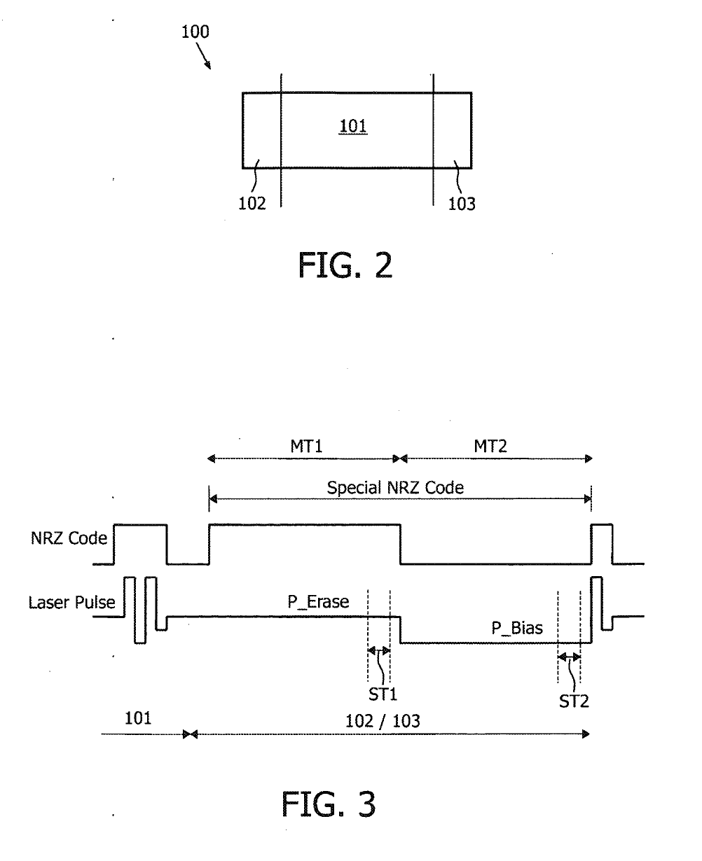

FIG. 2 illustrates a data format within run-in and run-out code,

FIG. 3 is a graph schematically showing a first and a second period according to the present invention,

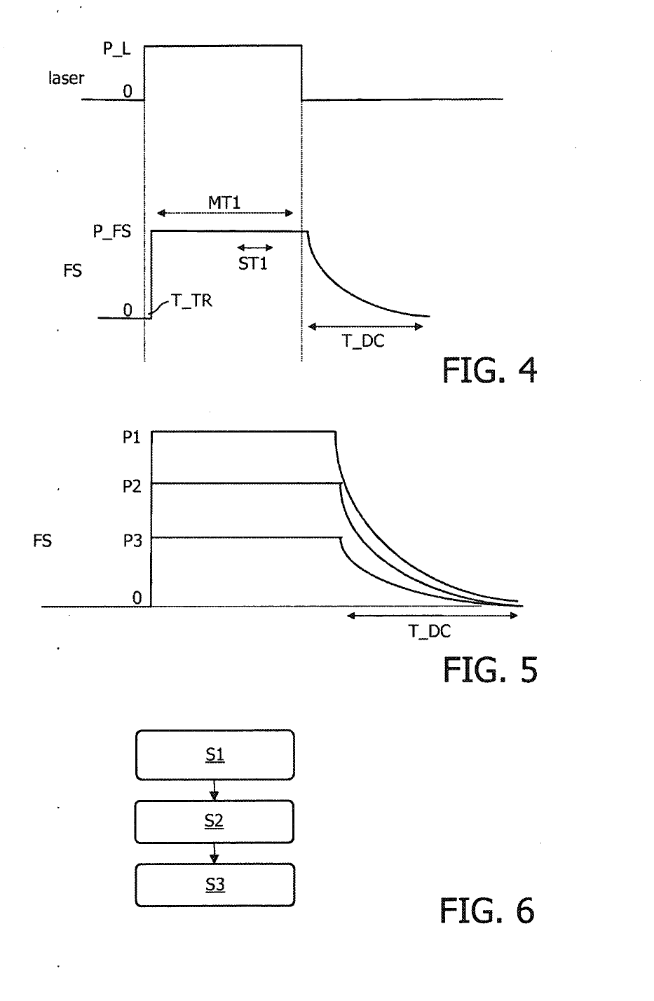

FIG. 4 is a graph schematically showing an emitted laser pulse and the corresponding response of the forward photo sensing means (FS),

FIG. 5 is a graph similar to the graph of FIG. 4 showing the response of the forward photo sensing means (FS) at three different power levels, and

FIG. 6 is a flow chart of a method according to the invention.

FIG. 1 shows an optical recording apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable regions, also called “marks” for rewriteable media, on the optical carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a laser driver device 30, a radiation source 4, a beam splitter 6, an objective lens 7, and lens displacement means 9 capable of displacing the lens 7 both in a radial direction of the carrier 1 and in the focus direction. The optical head 20 also comprises forwarding photo sensing means (FS), said sensing means comprising a photo detector 40, also known as the forward detecting monitor (FDM), and an amplifier 41, e.g. a current to voltage converter (I-V), with a scalable electrical output signal FS_S that is transmitted to the processor 50 for further processing and analysis.

The function of the forwarding photo sensing means (FS) is to control the power level of the emitted radiation 5 from the irradiation source 4. A beam fraction 39 of the radiation beam 5 is directed from the beam splitter 6 towards the photo detector 40 so as to obtain a measure of the power of the radiation beam 5. Knowing the characteristics of the beam splitter 6 this is a standard procedure. Alternatively, the photo detector 40 may be positioned within the beam 5 so as to obtain a more direct measure of the power of the radiation beam 4.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where commonly known servomechanism operated by usage of PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc.

The radiation source 4 is controlled by the laser driver device (LD) 22. The laser driver (LD) 22 comprises electronic circuitry means (not shown in FIG. 1) for providing a control current to the radiation source 4 in response to a clock signal and a data signal NRZ transmitted from the processor 50. The processor 50 receives feedback, i.e. the FS_S signal, from the forward sensing means (FS) so as to assess the actual value of the power in the irradiation beam 5. If a deviation exits between the desired target level of power and the actual value of the power in beam 5, the processor 50 may generate appropriate control signals to the laser driver 22 and the radiation source 4 to correct the actual power level. Thus, a feedback control loop is established to control the power of the irradiation beam 4. The deviation between the desired target level of power and the actual value of the power in beam 5 is usually defined as a power error, and the function of the laser power control loop is to minimize, and if possible eliminate, the power error. In an embodiment, the amplifier 41 may be integrated into the laser drive 22. Alternatively, the amplifier 41 may be positioned outside the optical head 20, possibly within or near the processor 50.

The processor 50 receives and analyses signals from the photo detection means 10. The processor 50 can also output control signals to the actuation means 21, the radiation source 4, the lens displacement means 9, and the rotating means 30, as schematically illustrated in FIG. 1. Similarly, the processor 50 can receive data to be written, indicated at 61, and the processor 50 may output data from the reading process as indicated at 60. While the processor 50 has been depicted as a single unit in FIG. 1, it is to be understood that equivalently the processor 50 may be a plurality of interconnecting processing units positioned in optical recording apparatus, possibly some of the units may be positioned in the optical head 20.

FIG. 2 illustrates in a schematic manner a data format with run-in and run-out code. According to the Blu-Ray disc (BD) rewriteable standard, a recording unit block (RUB) 100 will have a run-in portion 102 and run-out portion 103 separated by a physical cluster 101. In the cluster 101 user data can be written, and accordingly the run-in 102 and run-out 103 may contain automatic power control (APC) regions for laser power control (LPC). The present invention may apply the APC regions to sample the power level of the irradiation beam 5.

It is however contemplated that the laser power control (LPC) may also be performed in a situation when the radiation beam 5 is positioned over a data region of the carrier 1. This may be the case if the radiation beam 5 is not focused on the data region of the carrier 1 or if the beam 5 is shut from the carrier 1. This may be obtained in multi-lens system by intentional misalignment of one or more lenses or with the lens 7 being a liquid immersion lens that may change optical properties, possibly so as to effectively shut the radiation beam 5 from the carrier 1. Alternatively, a defocus mechanism may be applied which reduces power to active layer but allows tracking to continue. Alternatively, if the data region of the carrier 1 contains corrupted data and/or data that need not be stored anymore, laser power control (LPC) according to the present invention may performed in such a data region.

Data recording on various carrier formats, such as the compact disc (CD) format, the digital versatile disc (DVD), and the Blu-Ray disc (BD), is performed by encoding the data according to a standard encoding scheme to obtain a NRZ signal to be transmitted to the optical head 20 for writing. In the table below corresponding carrier formats and encoding schemes are listed:

| Carrier | | Maximum Code Run Length |
|---|---|---|
| formats | Encoding scheme | (MRL) |
| CD | 2.10 EFM | 11T |
| DVD | 2.10 EFM+ | 14T |
| BD | 1.7 PP | 9T |

In addition, the maximum code run length (MRL) of each encoding scheme is listed in the right column. The maximum code run length (MRL) indicates the maximum allowable mark or space length as an even multiple of the channel bit length (1T). Thus, for BD the maximum code run length is nine times the channel bit length. EFM is the commonly known abbreviation for Eight-to-Fourteen Modulation. The present invention is not limited to the above listed carrier formats. Rather, the invention is particularly suited for laser power control (LPC) at high speed writing in general.

FIG. 3 is a graph schematically showing a first period MT1 and a second period MT2 according to the present invention. In the upper curve, a NRZ code is schematically indicated, whereas the lower curve indicates the corresponding response of the laser or irradiation source 4. Hence, to the left an elevated constant NRZ level is indicated, which is transformed by the write strategy into a multi-pulse train of laser pulse so as to write a data in cluster 101 as shown in FIG. 2. During the run-in 102 and/or run-out 103 a special NRZ code is outputted from the processor 50 resulting in a constant power level of the beam 5. Of course the write strategy should accordingly be adapted in order to implement this functionality of the present invention.

The power level of the irradiation beam 5 is sampled by the forward photo sensing means (FS) 40 and 41 during a substantially constant power level in a first sub-period ST1 as shown in FIG. 3. The first sub-period ST1 is longer than the period of time associated with the maximum code run length (MRL). Usually, the power level being set to constant value will result in a constant actual power level but under some conditions, e.g. influence of noise, defects, etc., this may not be the case, and the laser power control (LPC) should detect such a discrepancy. As indicated in FIG. 3, the power level during MT1 is the erase level P_{Erase}. At the end of the first period MT1, a sub-period ST1 of for sampling of the erase power level is indicated.

The first period MT1 is followed by a subsequent second period MT2 where a predefined NRZ code is transmitted to the optical head 20 i.e. the laser drive (LD) 22 resulting in substantially constant power level i.e. a bias power level, P_{Bias}, as indicated in FIG. 3. As before a sub-period ST2 of the second period MT2 is applied for sampling i.e. actual measurement of the laser power level by the forward sensing means 40 and 41 that is transmitted as a forwarding sensing signal FS_S and registered as a power level in the processor 50.

Sampling two levels as shown in FIG. 3 allows direct and independent measurement of the threshold current, Iₜ, of the irradiation source 4 and the relative efficiency, η. If use is made of the relationship between laser threshold current, Iₜ, and laser efficiency, η, across temperature as described in U.S. Pat. No. 6,577,655 and WO 2004/105005 A1, then it is possible with one such power level and one period MT1 to achieve full power control. U.S. Pat. No. 6,577,655 and WO 2004/105005 A1 are hereby incorporated by reference in their entirety. By application of the principles set forth in U.S. Pat. No. 6,577,655, information of one power level is used to control two currents, and these two currents are used to control the laser current driver (threshold and slope) such that all power levels remain correct across the temperature range used. Using the principles set forth in WO 2004/105005 A1, the use of information from two power levels is used to calibrate the relationship thereby allowing one power level and a relationship to even more accurately (adaptive calibrated relationship) control two currents, and these two currents are used to control the laser current driver (threshold and slope) such that all power levels remain correct across the temperature range used. In addition both these applications show how the relationship is designed such that it remains intact even when the actual power level is varied by OPC (optimum power control) by nature of the relationships chosen.

FIG. 4 is a graph schematically showing an emitted laser pulse 5 in the upper part of FIG. 4, and the corresponding response of the forward photo sensing means (FS) 40 and 41 is shown in the lower part of FIG. 4. For illustrative purposes the laser pulse is shown as a simple step function having an upper level P_L and zero level. With two vertical, dashed lines, the start and the end of the laser pulse is indicated.

As seen in FIG. 4, the sensing means FS has a certain delay T_TR before the onset of the laser pulse is detected. This delay may attributed to the internal delays of the photo detector 40 and/or the amplifier 41 and it is typically in the order of 2-50 nanoseconds depending on the laser light wavelength used, the forward sense reverse voltage used, the amplifier gain, and type/configuration of amplifier 41 used. At the end of the laser pulse, the sensing means 40 and 41 exhibit a characteristic tail, which represents photon recombination in diffusion field zones of photo detector 40 and/or settling time of the amplifier 41. Mathematically, the decay may be represented as exponential decay with a time constant in the range from 5-200 nanoseconds depending on the laser light wavelength used, the forward sense reverse voltage used, the amplifier gain, and type/configuration of amplifier used. After a period of time T_DC the decay is effectively zero. In case of an active amplifier, the decay may be shifted slightly in time in the right direction of the graph in FIG. 4.

The first period MT1 should be chosen so as to take into account the above-mentioned delays T_TR and T_DC, i.e. the period MT1 is set with a margin separating the period MT1 from these transition effects of the forwarding sensing (FS) system.

FIG. 5 is a graph similar to the graph of FIG. 4 showing the response of the forward photo sensing means (FS) with three different power levels, P1, P2, and P3. Knowing the characteristics of the splitter 6, the photo detector 40 and the amplifier 41 it is possible to directly perform a measurement of the power of the irradiation beam 5. For illustrative purposes three power levels are shown as present laser write strategies often comprise three power levels; a write level, P_{Write}, an erase level, P_{Erase}, and a bias level, P_{Bias}. In order to avoid unnecessary heating of the irradiation source 4, the higher power levels are typically sampled at only at a fraction of the nominal value. For example the write level may be measured indirectly at half the value; P=P_{Write}/2. Taken into account the laser power control measurement at e.g. half the target power and knowing the threshold current, Iₜ, of the irradiation source 4 and the relative efficiency, of the irradiation source 4 it is possible to predict the sufficient laser current, I, with a high degree of certainty so as to obtain the desired output power in the irradiation beam 5.

FIG. 6 is a flow chart of a method according to the invention operating an optical recording apparatus for recording on an optical carrier 1. The method comprising the steps of:

S1 emitting an irradiation beam 5 from an irradiation source 4, said beam being capable of recording data in a data region 101 in response to an predefined input signal NRZ, said predefined input signal NRZ being encoded with an encoding scheme having a maximum code run length (MRL). The irradiation beam 5 has a substantially constant power level in a first period MT1, said first period being longer than the period of time associated with the maximum code run length (MRL),

S2 monitoring by forward photo sensing means (FS) the power level, P, of the irradiation beam 5 emitted from the irradiation source 4, and

S3 sampling the power level of the irradiation beam in at least a sub-period of time ST1 of the first period MT1.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical recording apparatus for recording on an associated optical carrier (1), said carrier comprising data regions (101) and optionally power control regions (102, 130), the optical recording apparatus comprising
an irradiation source (4) adapted for emitting an irradiation beam (5), said beam being capable of recording data in a data region (101) in response to an predefined input signal (NRZ), said predefined input signal (NRZ) being encoded with an encoding scheme having a maximum code run length (MRL), and
forward photo sensing means (FS, 41, 40) adapted for monitoring the power level of the irradiation beam (5) emitted from the irradiation source,
wherein the irradiation beam (5) has a substantially constant power level in a first period (MT1), said first period (MT1) being longer than the period of time associated with the maximum code run length (MRL), the forward photo sensing means (FS 41, 40) being adapted to sample the power level in at least a sub-period of time (ST1) of the first period (MT1).

2. An optical recording apparatus according to claim 1, wherein the first period (MT1) is at least two times, preferably at least three times, and even more preferably at least four times, longer than the period of time associated with the maximum code run length (MRL).

3. An optical recording apparatus according to claim 1, wherein the forward photo sensing means (FS) comprises a photo detector (40) and an amplifier (41) connected thereto, the amplifier being adapted for outputting an electrical signal (FS_S) indicative of the power of the radiation beam (5).

4. An optical recording apparatus according to claim 3, wherein the power level is substantially constant after a transient rise period (T_TR) of the photo detector (40) and/or the amplifier (41).

5. An optical recording apparatus according to claim 3, wherein the power level is substantially constant before a decaying fall period (T_DC) of the photo detector (40) and/or the amplifier (41).

6. An optical recording apparatus according claim 4, wherein the length of first period (MT1) is related to a characteristic decaying fall period (T_DC) of the photo detector (40) and/or the amplifier (41).

7. An optical recording apparatus according to claim 1, wherein the sampled power level is applied in connection with a relationship between the power level of the irradiation beam (5) and a current (I) driving the radiation source (4).

8. An optical recording apparatus according to claim 7, wherein at least one additional sampled power level is applied to calibrate a relationship between the power level of the irradiation beam (5) and a current (I) driving the radiation source (4).

9. An optical recording apparatus according to claim 1, wherein the substantially constant power is sampled before and/or after a data region (101) of the associated optical carrier (1).

10. An optical recording apparatus according to claim 1, wherein the irradiation beam (5) additionally has a substantially constant power level in a second period (MT2), said second period being longer than the period of time associated with the maximum code run length (MRL), the forward photo sensing means (FS, 40, 41) being adapted to sample the power level in at least a sub-period of time (ST2) of the second period (MT2).

11. An optical recording apparatus according to claim 1, wherein the power level in the first period (MT1) is chosen from the group of: write level (P_{Write}), erase level (P_{Erase}), and bias level (P_{Bias}).

12. Processing means (50, 22) adapted for controlling an optical recording apparatus capable of recording on an optical carrier (1), said carrier comprising data regions (101) and optionally power control regions (102, 103), the processing means being adapted to
1) forward a predefined input signal (NRZ) to an irradiation source (4), said predefined input signal (NRZ) being encoded with an encoding scheme having a maximum code run length (MRL), wherein an irradiation beam (5) of the irradiation source has a substantially constant power level in a first period (MT1), said first period being longer than the period of time associated with the maximum code run length (MRL), and
2) receive a forward sensing signal (FS_S) indicative for the power level of an irradiation beam (5) emitted from the irradiation source (4),
the processing means (50, 22) further being adapted to sample the power level of the irradiation beam in at least a sub-period of time (ST1) of the first period (MT1).

13. A method for operating an optical recording apparatus for recording on an optical carrier (1), said carrier comprising data regions (101) and optionally power control regions (102, 103), the method comprising the steps of
emitting an irradiation beam (5) from an irradiation source (4), said beam being capable of recording data in a data region (101) in response to an predefined input signal (NRZ), said predefined input signal (NRZ) being encoded with an encoding scheme having a maximum code run length (MRL), wherein the irradiation beam (5) has a substantially constant power level in a first period (MT1), said first period being longer than the period of time associated with the maximum code run length (MRL),
monitoring by forward photo sensing means (FS) the power level of the irradiation beam (5) emitted from the irradiation source (4), and
sampling the power level of the irradiation beam in at least a sub-period of time (ST1) of the first period (MT1).

14. A computer program product being adapted to enable a computer system comprising at least one computer having data storage means associated therewith to operate an optical recording apparatus according to claim 13.
